(19) United States
(12) Patent Application Publication
(10) Pub. No.: US 2016/0161596 A1
(43) Pub. Date: Jun. 9, 2016

(54) Stationary doppler target suppressor

(71) Applicant: Federal Aviation Administration/Department of Transportation/Government of the United States, Washington, DC (US)

(72) Inventor: Daniel Parrott, Oklahoma Ciity, OK (US)

(73) Assignee: Federal Aviation Administration/Department of Transportation/Government of the United States, Pomona, NJ (US)

(21) Appl. No.: 14/121,849

(22) Filed: Oct. 24, 2014

(51) Int. Cl. G01S 7/292

(52) U.S. Cl. CPC G01S 7/2922

(57) ABSTRACT

A device and method to suppress clutter generated by stationary targets that also have moving components that give significant Doppler returns when scanned by radar, such as wind turbines.

### STATEMENT OF GOVERNMENT INTEREST

The present invention may be made or used by or on behalf of the Government of the United States without the payment to me of any royalties therefor or thereon.

### DRAWINGS

FIG. 1. Two idealized Doppler filter banks.

FIG. 2. Strength of Doppler Returns versus Scan Number and Time for Doppler radar-observing a cell containing a single wind turbine with rotating blades, also threshold set according to maximum Doppler return.

FIG. 3. Illustration of situation of FIG. 2 with threshold reset every 20 scans.

FIG. 4. Illustration of situation of FIG. 2 with threshold reset according to maximum Doppler return experienced in preceding 20 scan period, using two storage buckets.

FIG. 5a. Illustration of situation of FIG. 2, using 8 buckets, 7 “write” and 1 “read.”

FIG. 5b. Illustration of situation Of FIG. 2, using 8 buckets, 6 “write”, 1 “read” and 1 “transition.”

FIG. 6. Illustration of situation with more active blade flash activity and corresponding threshold.

FIG. 7. Spreadsheet showing the contents of each bucket over the first 30 scans of the wind turbine analyzed in FIG. 6.

FIG. 8. Radar device illustrating embodiment of invention during scans 4, 5, and 6 of wind turbine under conditions shown in FIG. 7.

### SPECIFICATION

Wind turbines can interfere with the ability of radar to detect targets. The large stationary structure on which the blades are mounted block the radar signal from seeing what lies in the immediate vicinity of the wind turbine. The large rotating blades can bounce the radar signal emitted by the radar transmitter back toward the radar receiver, and may appear like substantial, large objects advancing or retreating at various speeds to and from the radar receiver. However, the radar system can distinguish stationary objects, like the turbine tower itself, from moving objects, like the turbine blades, by application of the Doppler Effect.

One technique employed in modern radar systems to suppress Doppler emissions from stationary targets is the Moving Target Detector (MTD) process by which Doppler returns are separated into separate filters according to the velocity of the reflecting source of the Doppler return. The output of these filters, then, represents a spectrum of velocities from the slowest to the fastest. Any target that is stationary, that is, has a Doppler return corresponding to an object moving at zero velocity toward or away from the radar, falls into what may be called Filter Zero, and anything that moves falls into the other filters. This generally allows for clutter to be separated from actual targets, except in the case of wind turbines. While the wind turbines themselves are stationary in position, the rotating blades nevertheless give off a Doppler return that the radar puts into at least one of the non-zero Doppler filters.

One type of radar system rotates and scans the region around it periodically, illuminating the cell containing the wind turbine upon each scan. The blades of the wind turbine, when turning, are not necessarily synchronized with the scanning rate of the radar so that the radar beam may not strike the blade at any predictable position in its rotation. Since most wind turbines are multiblade devices, the radar may not even strike the same blade or, indeed, any blade, on a particular scan. If the scanning beam should strike the moving blade when some part of the blade is perpendicular to the beam, the return is at a maximum; when no part of the blade is perpendicular to the beam, the return is at a minimum. Positions in between will result in reflected powers in between these maxima and minima. Other factors, such as the direction and speed of the wind driving the turbine, and the plane of rotation of the blades, may play a role as well.

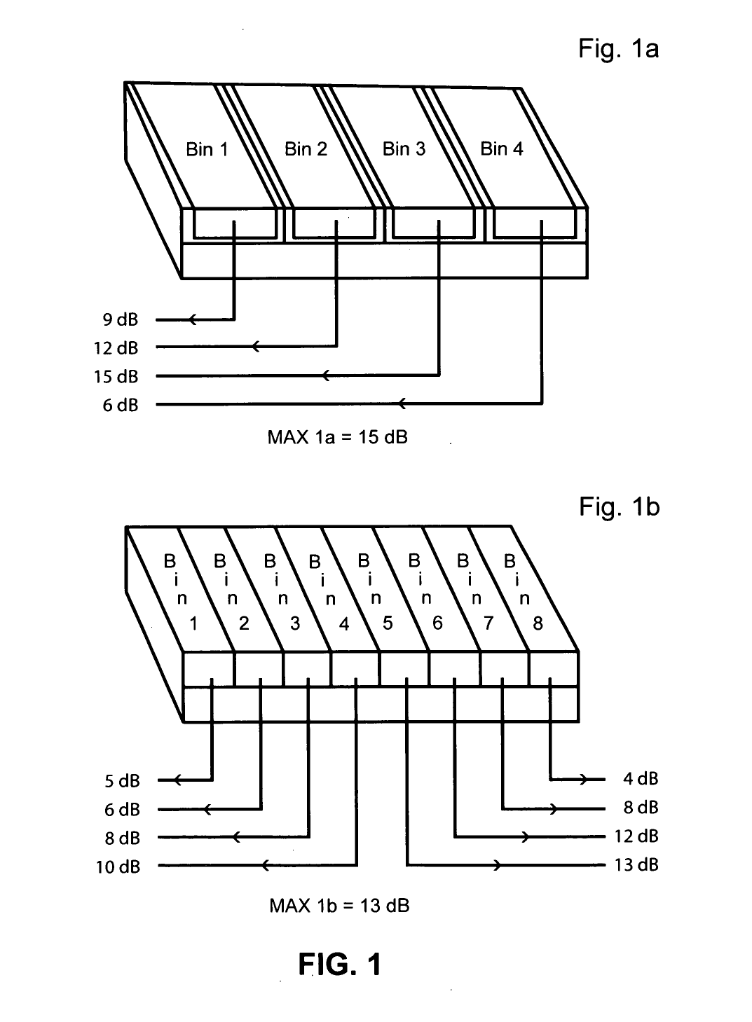

For the present invention, I chose to measure, select, and retain the maximum Doppler return for each scan of the cell containing a wind turbine regardless of which non-zero Doppler filter the maximum return occurs. FIG. 1 consists of two cases of non-zero Doppler filters as examples. FIG. 1a shows a 4 bin filter bank, each capable of receiving Doppler returns that have been separated according to the velocity of the reflecting object captured by the Doppler radar. FIG. 1a illustrates the case where the lowest velocities fall into Bin 1 and the highest into Bin 4. Intermediate velocities are spread between these extremes. Not shown is the typical Bin Zero, or Filter Zero, which would represent non-moving objects: generally clutter generated by stationary reflectors such as buildings, bridges, land masses, vegetation, and towers, including the towers that would support the nacelles and blades of the wind turbines. Such non-moving objects should not have a Doppler component. Since the highest Doppler return is found in Bin 3 for this scan depicted in FIG. 1a, Bin 3 is identified, and the 15 dB output is selected and recorded as the maximum Doppler return. Should the Doppler filter be an 8 bin filter bank as illustrated in FIG. 1b, with the corresponding Doppler components as illustrated, the maximum Doppler return for that scan would be 13 dB because Bin 5 has the highest Doppler return of all the 8 bins. Of course, any number of bins could be imagined, but the principle would remain the same, namely the maximum Doppler return for a particular scan is that maximum Doppler return that can be found in any of the non-zero bins.

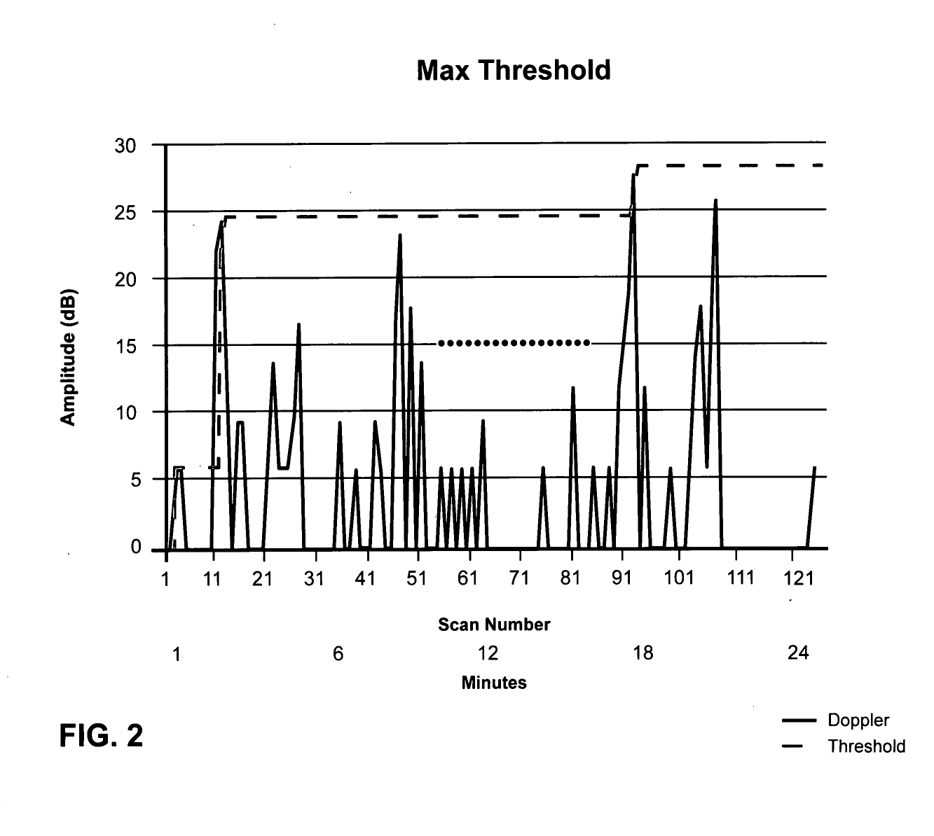

In FIG. 2, the horizontal axis represents the scan number and the time over which the scan data was collected while the vertical axis represents the strength of the reflected Doppler return detected at the radar receiver. A horizontal threshold value can be set as illustrated with dashed lines such that Doppler signals received below this threshold value are ignored while signals above this threshold value are counted as returns from moving targets other than the blades of the wind turbine, i.e. real targets. While this approach will eliminate practically all “false alarms”, i.e. Doppler returns from the wind turbine erroneously counted as encounters with real targets, it will certainly miss all real targets with return signals less than the maximum wind turbine blade return. That is, the probability of detecting a real target is much less than the probability of experiencing a false alarm.

One way of improving the possibility of detecting a real target and reducing the probability of a false alarm would be to lower the threshold in those regions where the returns from blade activity is low. For instance, in FIG. 2, if the threshold were reduced between scans number 52 to 85 to a value of about 15, then the sensitivity of the radar system would be greatly increased with little danger of false alarms from the wind turbine and a maximum probability of detection of real targets. Of course, an accurate choice of a lower threshold between these two scans depends entirely on knowing ahead of time when flashes of Doppler return power caused by the wind turbine will be. One cannot predict what the magnitude of the Doppler return signal will be based solely on the magnitude of the Doppler return signal from the immediately preceding scan. However, there is useful historical information that can be used to effectively set thresholds for the present and immediate future that can minimize false alarms caused by the rotating blades of the wind turbine while maximizing the probability that, for the next period of time, no significant false alarms from the wind turbine will be recorded. Such useful information can be extracted from the maximum power of the Doppler return measured on each scan of the region occupied by the wind turbine, and the knowledge that, in general, for a real wind turbine under usual conditions, blade flashes will occur every six to 10 scans. The threshold lowering thus determined can increase the likelihood of detecting a real target even though it will raise the probability of encountering a false positive, but to an acceptable degree.

### Example 1

### Permanent High Threshold

One approach that uses the maximum Doppler return of a series of scans of a region containing a wind generator is illustrated in FIG. 2. The threshold is set at the level of the initial value of the maximum Doppler return signal from scan number land the strength of the maximum Doppler return signals from subsequent scans is continually measured; That initial threshold is established by the initial maximum Doppler return and maintained until a value of a maximum Doppler return greater than that which was set from scan number 1 is received. At this point, that greater value is set as the threshold until an even greater return is received and that value is set as the new threshold. Simply stated, the threshold is continually re-established at the maximum Doppler return and held at that level until an even higher maximum Doppler return is received. This new maximum is then set as the threshold.

This approach will eventually result in a threshold so high that practically all blade flashes from the wind turbine are suppressed. In this example, there is no mechanism for allowing the threshold to decay to lower limits.

### Embodiment 1

### High Threshold with Periodic Reset to Lower Threshold

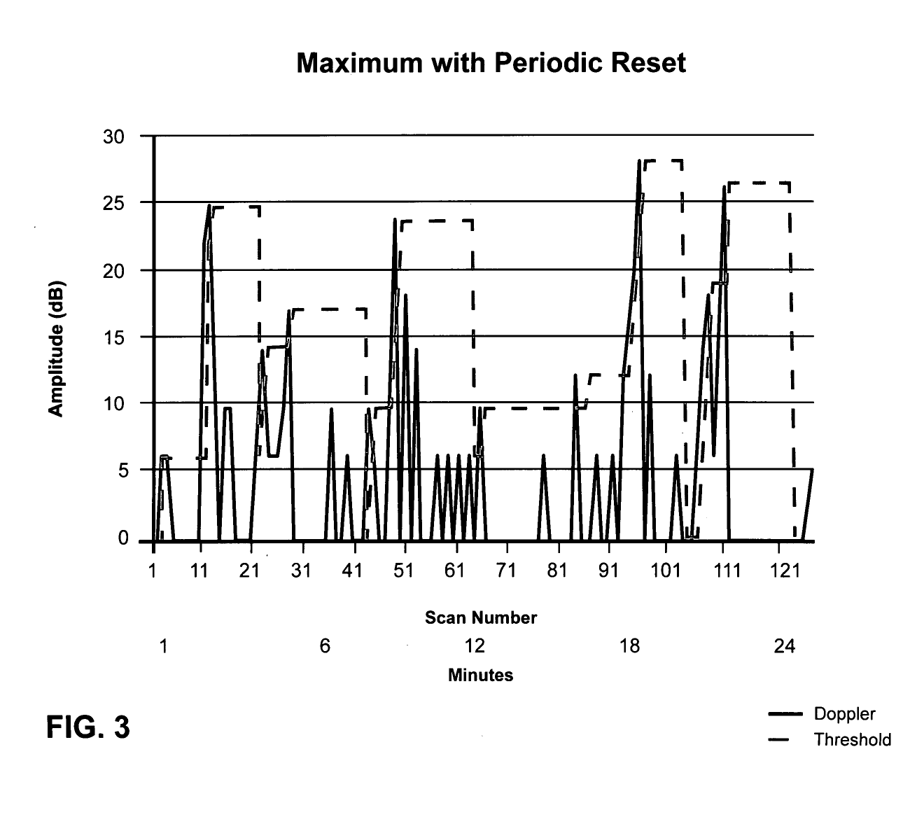

Embodiment 1 of the present invention allows the threshold level to decay with time. While this approach may allow for more frequent false alarms, it would allow for periods of time when the sensitivity of the radar is enhanced to allow for the detection of more real targets. In this embodiment, illustrated in FIG. 3, the initial threshold is set to the value of the strength of the Doppler return from the first scan. A specified set of subsequent scans are examined, and if no return is greater than that original scan during that number of scans, the threshold is set to the value of the last scan received. If the threshold had been reset during the period when the set number of scans was being examined, that is, if a higher maximum Doppler return had been encountered during the counting period, the higher maximum is set as the new threshold, but the counting of the set number of scans continues to N, as in this case, until 20 scans have been accumulated. Since it was the arrival of a strong Doppler return during that 20 scan period that caused the subsequent rise in the threshold, this approach will certainly result in at least one false alarm but the ability to detect a real target has been improved during the period the threshold had been lowered.

In FIG. 3, the threshold is allowed to decay periodically. In this case, the set number of scans is established at 20, so that after every 20 scans, the threshold is reset to the current value of the Doppler return and the process begins again. After the next 20 scans the threshold is again reset to the current amplitude of the Doppler return.

### Embodiment 2

### History of Maximum Doppler Return Sets Threshold Introduction of the Use of Buckets

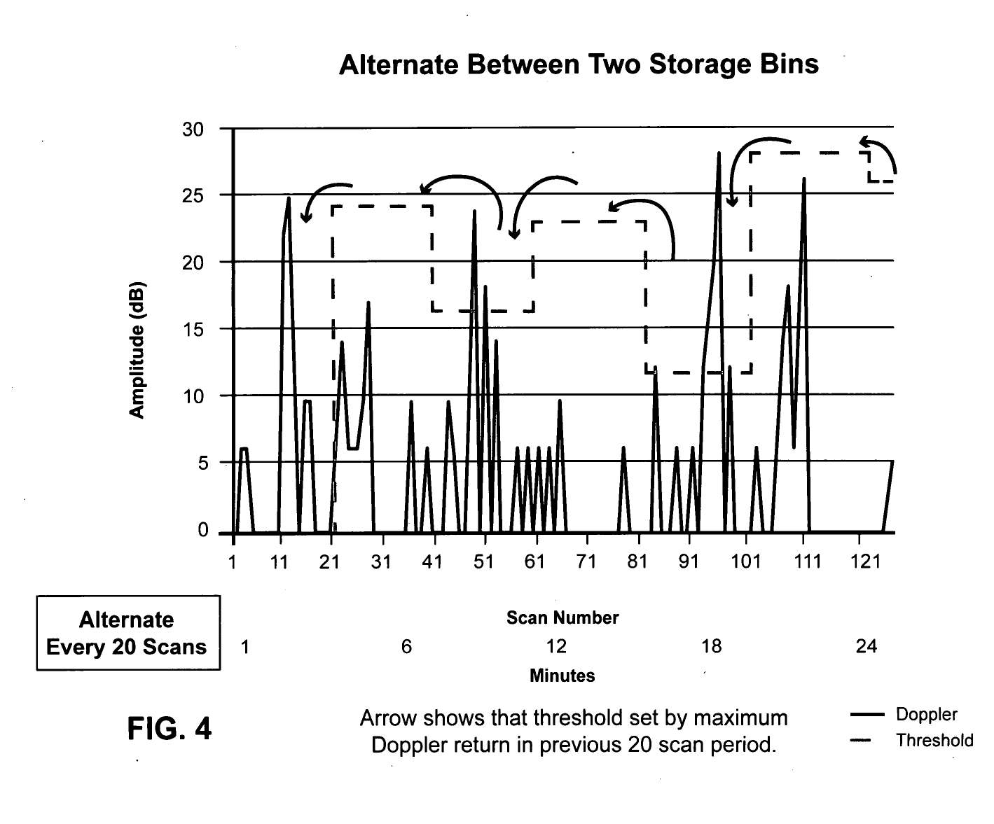

In Embodiment 2, illustrated in FIG. 4, the history of maxima during the previous 20 scans (a number which is adjustable) has been gathered in a “write” bucket. At the conclusion of the 20 scans, the maximum value contained in that bucket is “read” and established as the threshold for the next 20 scan period. That is, the maximum Doppler return recorded in that bucket during that 20 scan period is “read” as a second bucket begins writing Doppler returns during the 20 scan period while the present threshold is in effect. At the conclusion of that 20 scan period, the content of the second bucket is “read” and the maximum value contained in that second bucket is set as the new threshold for the next 20 scan period as the original bucket begins to accumulate maxima. The roles of the two buckets switch back and forth as the process progresses.

Note that the difference between Embodiment 1 and Embodiment 2 lies in how the reset value of the threshold is chosen. In Embodiment 1, the new threshold looks to the current amplitude of the most recent scan just before the scan period ends. In Embodiment 2, the new threshold is established by choosing the maximum Doppler return measured during the most recent scan period. When the threshold is chosen in accordance with Embodiment 2, the threshold may remain elevated for a longer duration than the period associated with Embodiment 1.

### Embodiment 3

### Slow-Moving Aircraft

It may happen that the maximum Doppler return from the blade flash of a wind turbine occurs at about the same time that an aircraft, is moving in the vicinity of the wind turbine. The relatively low power of the return from the aircraft is overwhelmed by the large value of the wind turbine flash. It would be advantageous to delay for a few scans the imposition of the high threshold to permit the Doppler return from the slow-moving aircraft to emerge from the expected lesser value returns from the wind turbine over these few scans after the maximum.

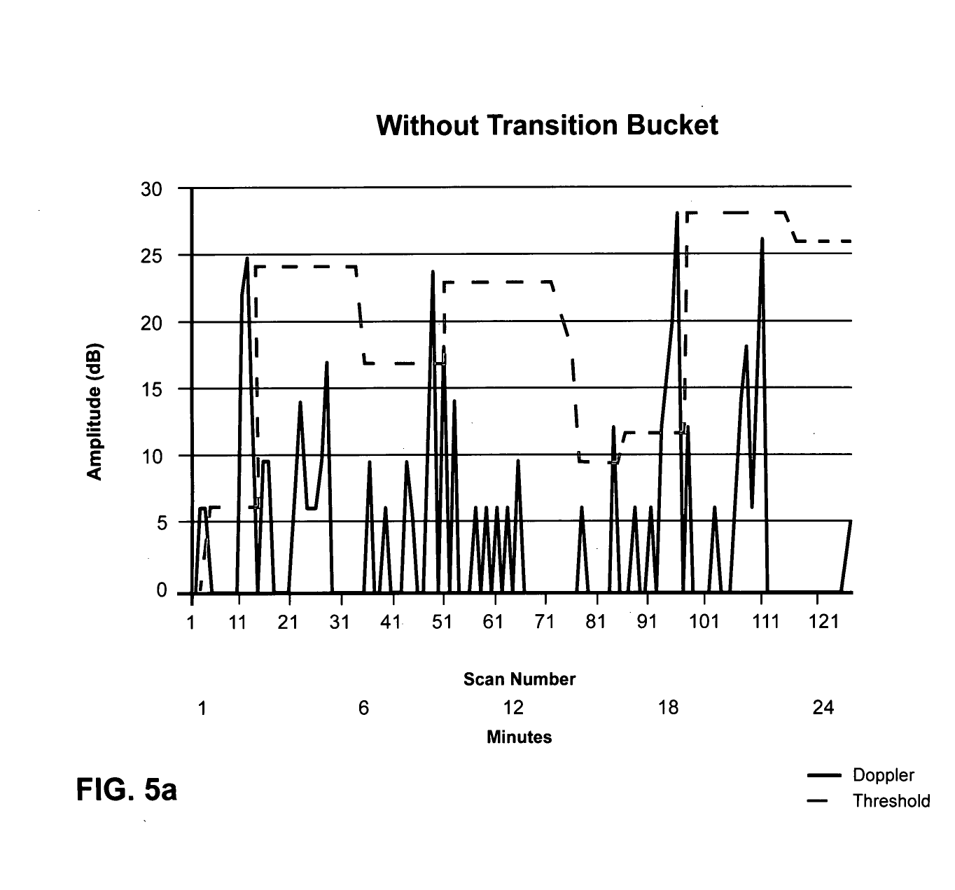

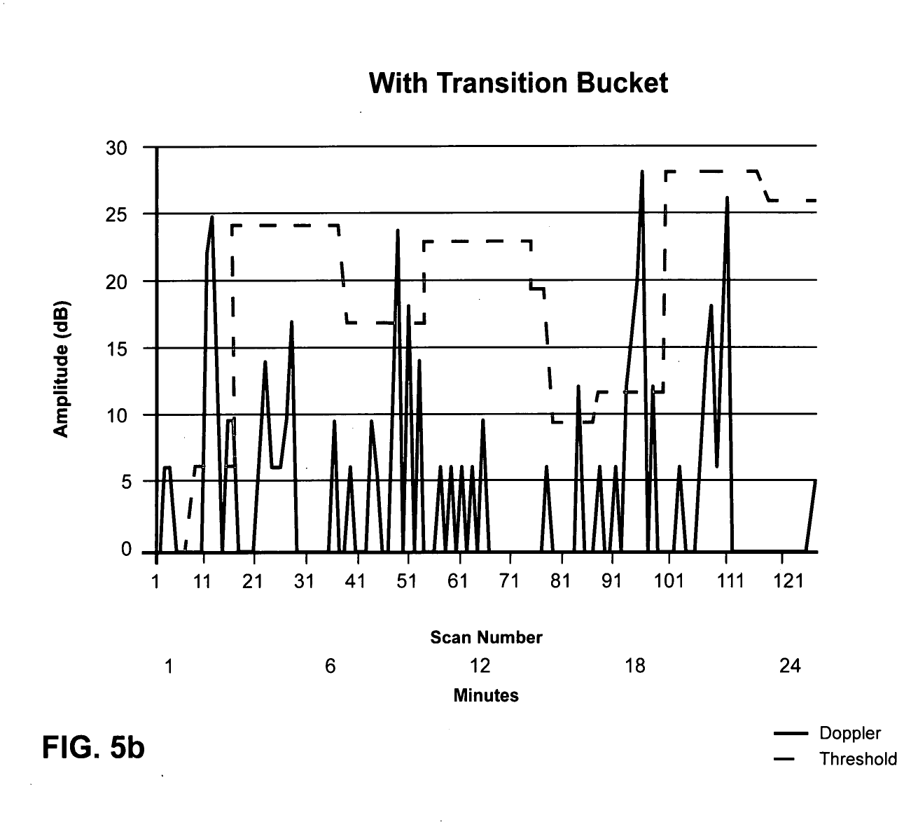

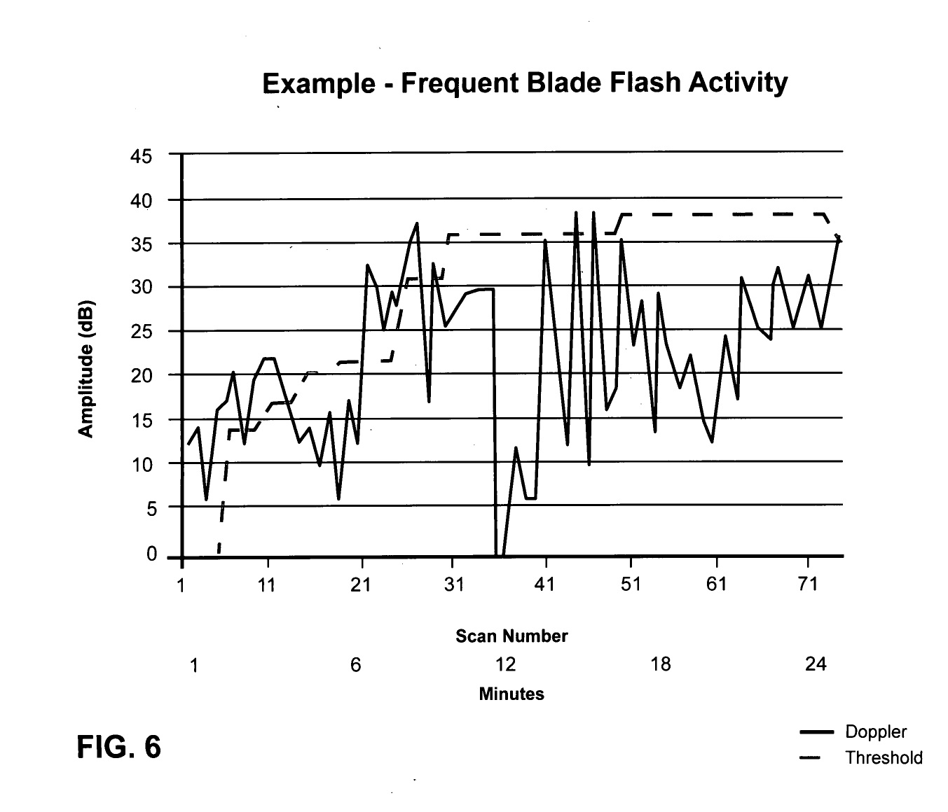

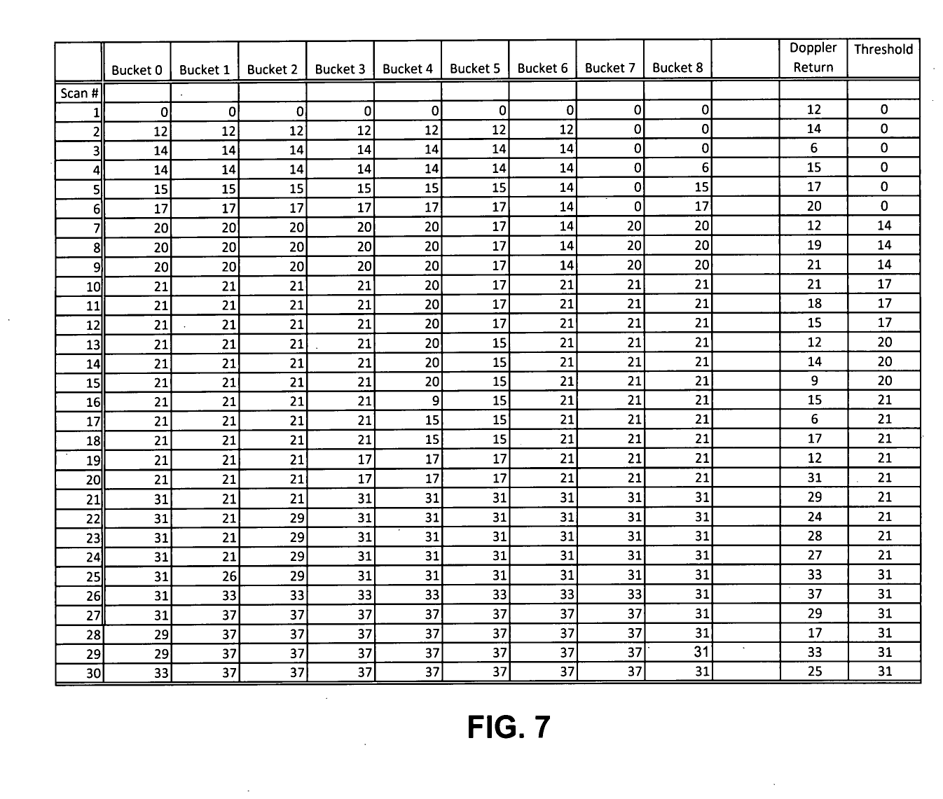

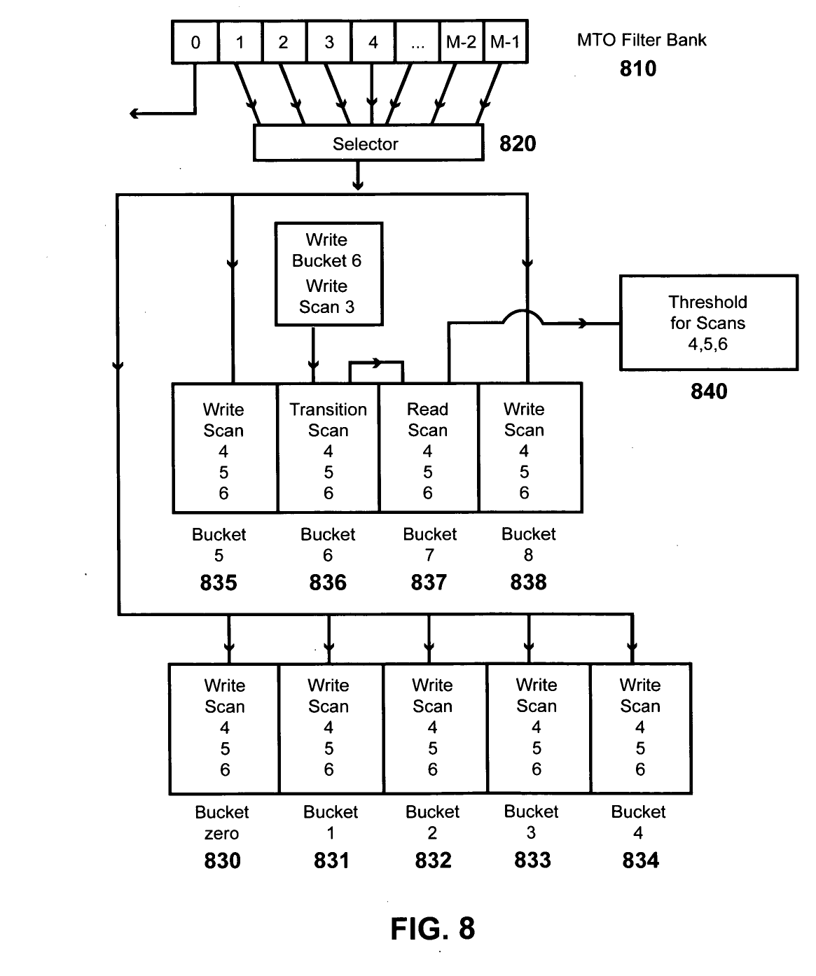

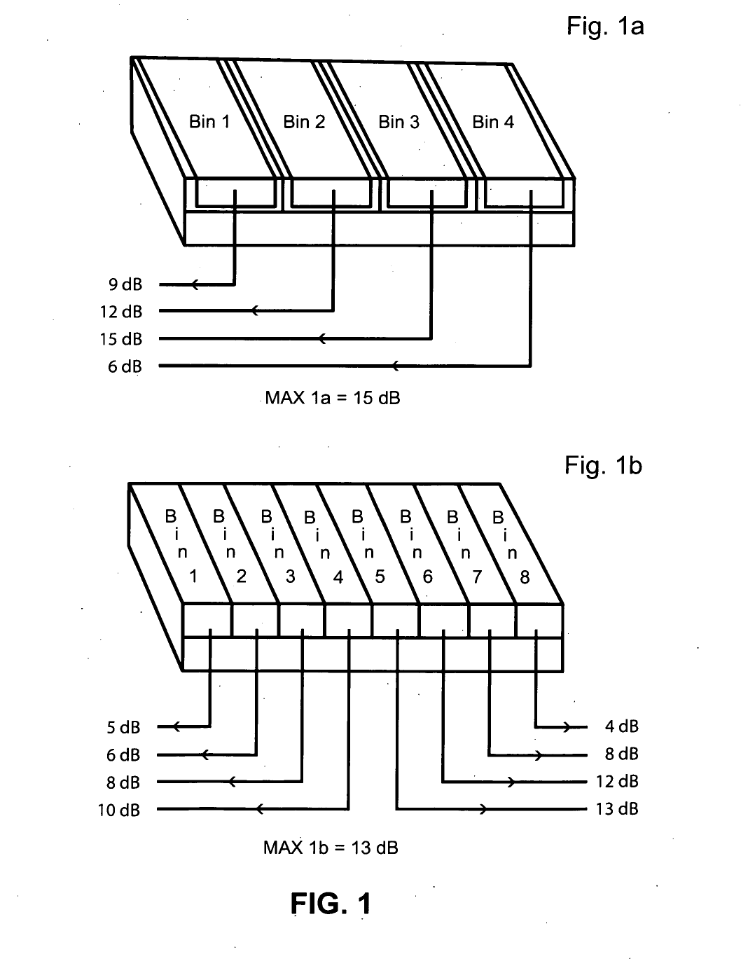

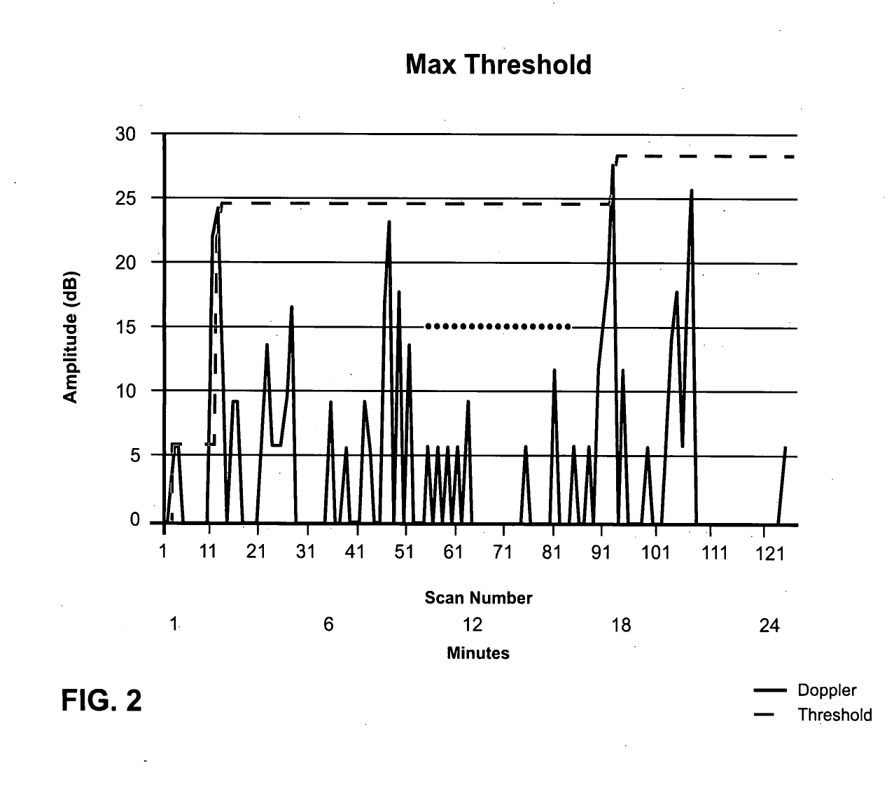

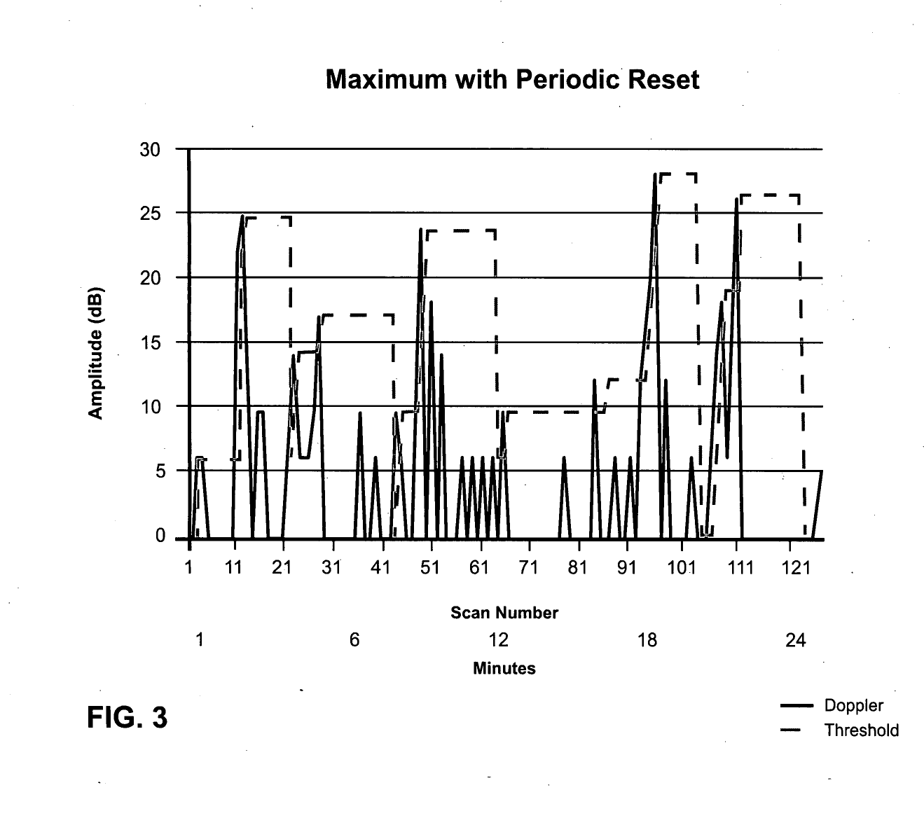

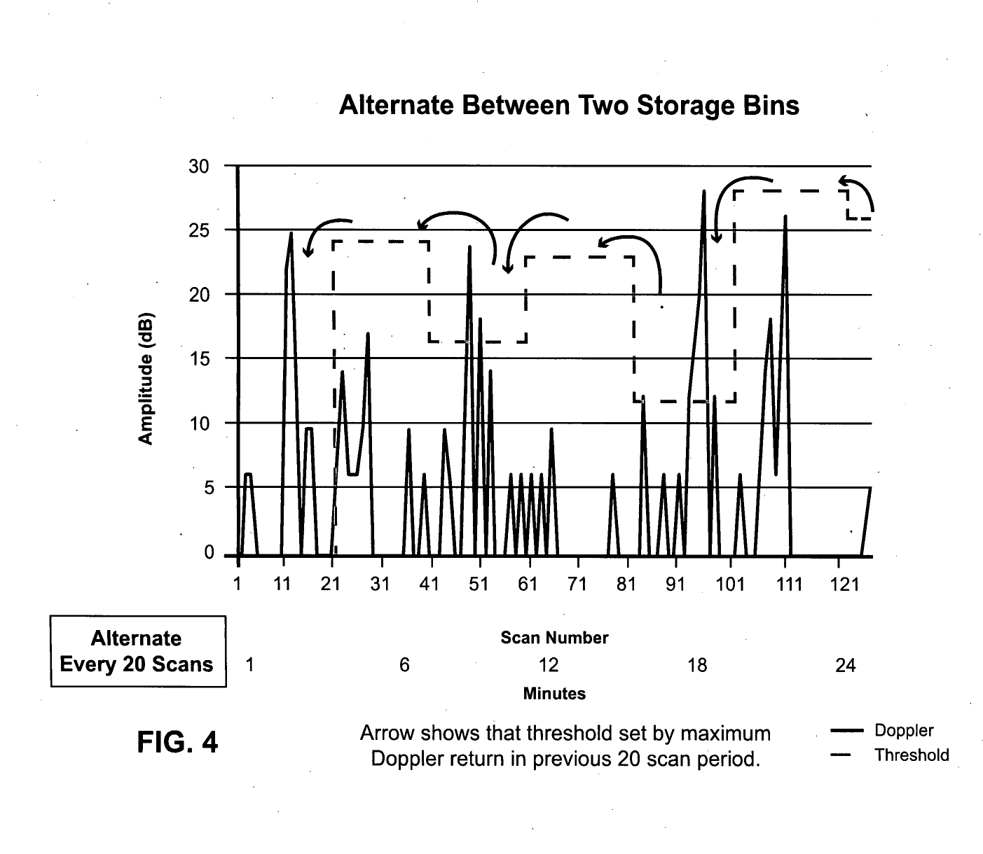

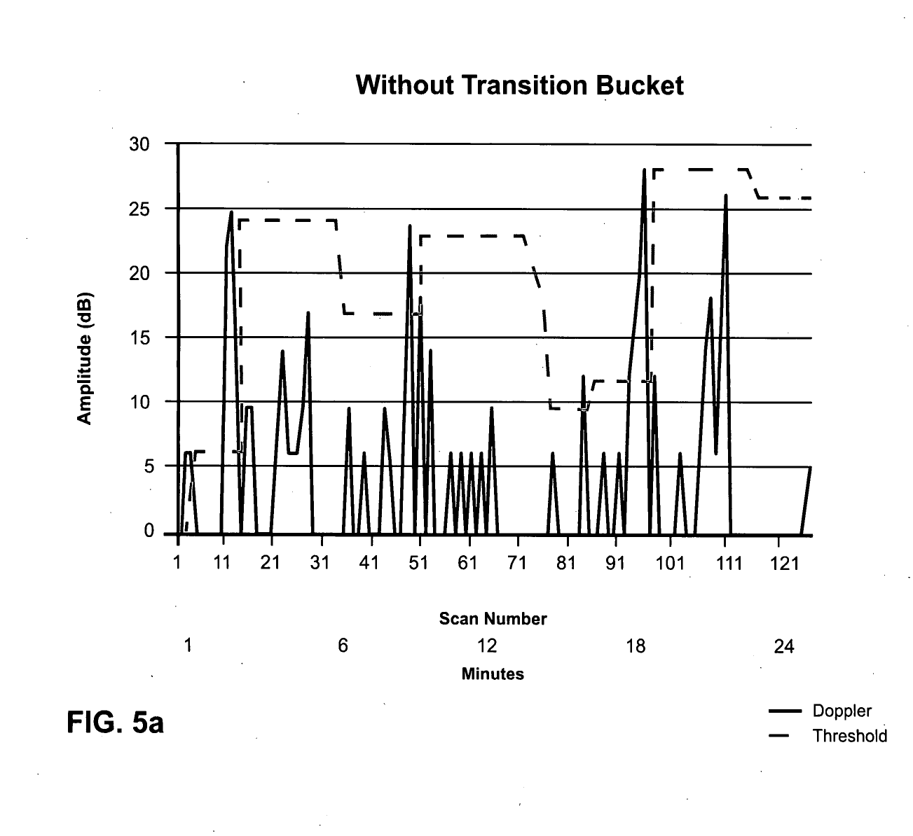

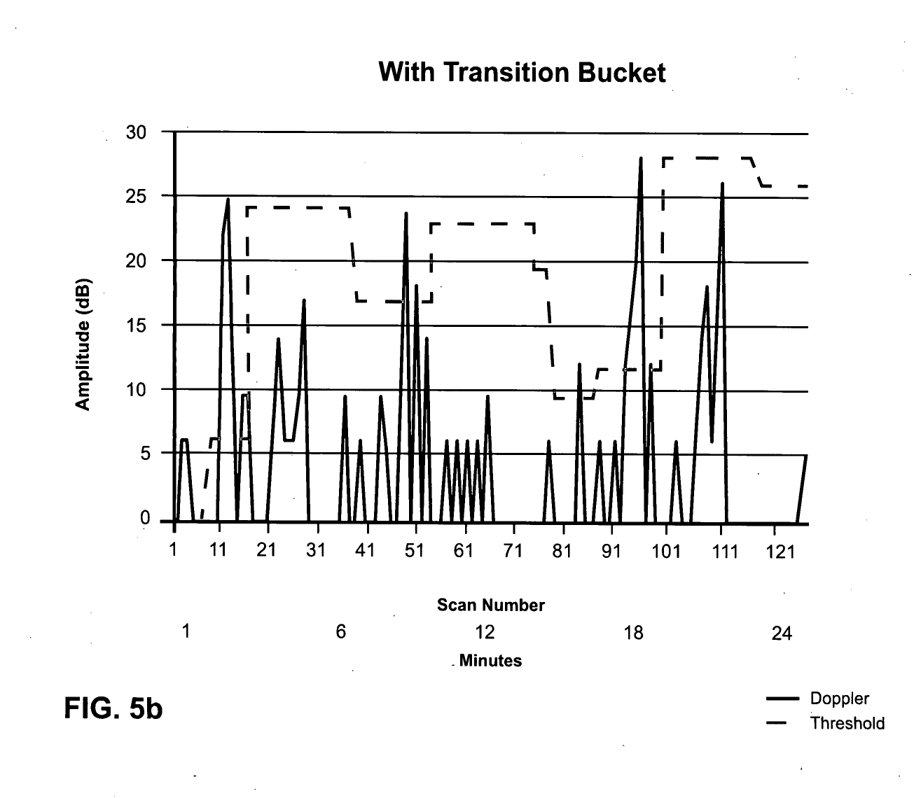

In FIGS. 5a and 5b can be seen the delaying effect of a “transition” bucket. In this embodiment of the invention, 8 buckets are used. In FIG. 5a, these buckets are deployed such that 7 are “write” and 1 is “read.” This means that the 7 “read” buckets are collecting the maximum value of the Doppler return from each scan, replacing if necessary the existing contents of the bucket with the maximum value. This collection continues for 3 scans as the value of the eighth bucket is read, and that value is established as the threshold for the following 3 scans. Once read, the “read” bucket becomes a “write” bucket, along with buckets 1 through 6, while bucket 7 becomes the new “read” bucket. Its content becomes the threshold for the next three scans. Once read, it too now becomes a “write” bucket along with buckets 1 through 5 and 8. At this point, buckets 1, 2, 3, 4, 5, 7, and 8 are writing values representing the maximum Doppler returns for the next three scans, while bucket 6 is being read and establishing the threshold for the next three scans. Notice that the buckets are being read in order.

In FIG. 5b the 8 buckets are deployed such that the bucket that feeds into the “read” bucket is the “transition” bucket. Its purpose is to delay the establishment of the new threshold after the contents of the present “read” bucket has been used to set the threshold. The content of the “transition” bucket retains or “freezes” the value it had just prior to the first scan of the present 3 scan set and inserts that value into the present “read” bucket. This technique acts to delay by 3 scans (in this embodiment) the setting of the new threshold. Note that the “transition” bucket is positioned such that it value feeds into the “read” bucket just before it is read. After the “read” bucket 8 is read, it becomes a “write” bucket; bucket 7, which had been the “transition” bucket becomes the “read” bucket; and, bucket 6 becomes the new “transition” bucket. To review: prior to being read, bucket 8 was the “read” bucket, bucket 7 was the “transition” bucket, and buckets 1 through 6 were “write” buckets. After bucket 8 was read, it became a “write” bucket, bucket 7 became the “read” bucket, bucket 6 became the “transition” bucket, and buckets 1 through 5 also became “write” buckets. The order in which the buckets were read continues to be from bucket 8, to 7 to 6, etc. After bucket 1, the process returns to bucket 8 and continues as long as desired.

### DETAILED DESCRIPTION

### Embodiment 4

### Multiple Buckets are Used to Adjust Delay in Ramping Up and to Extend Time for Threshold to Decay

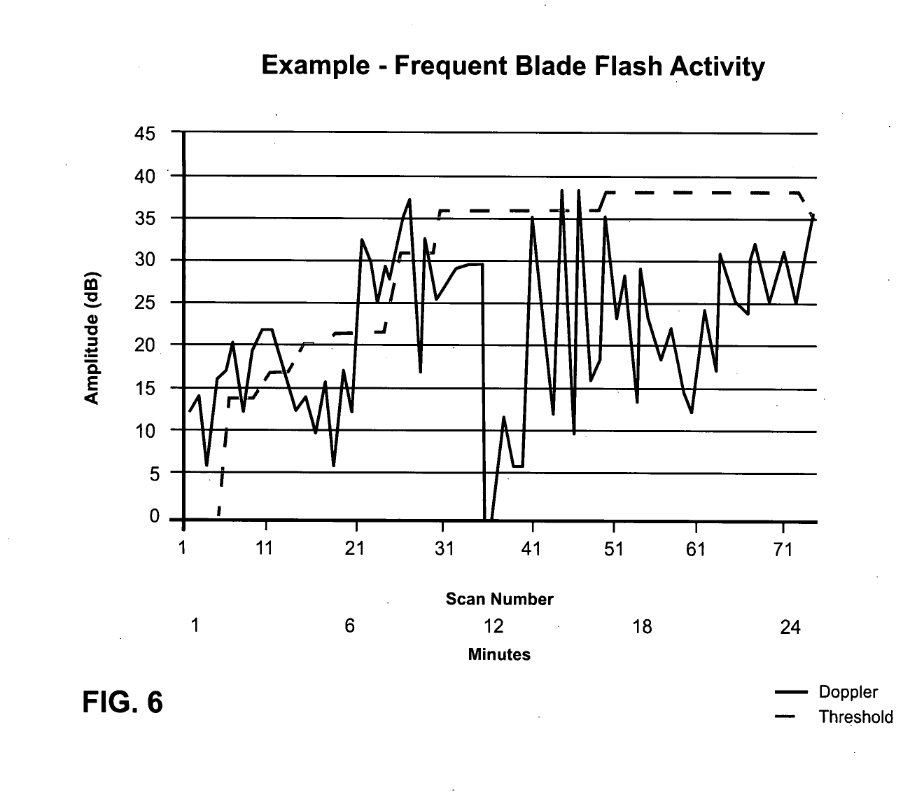

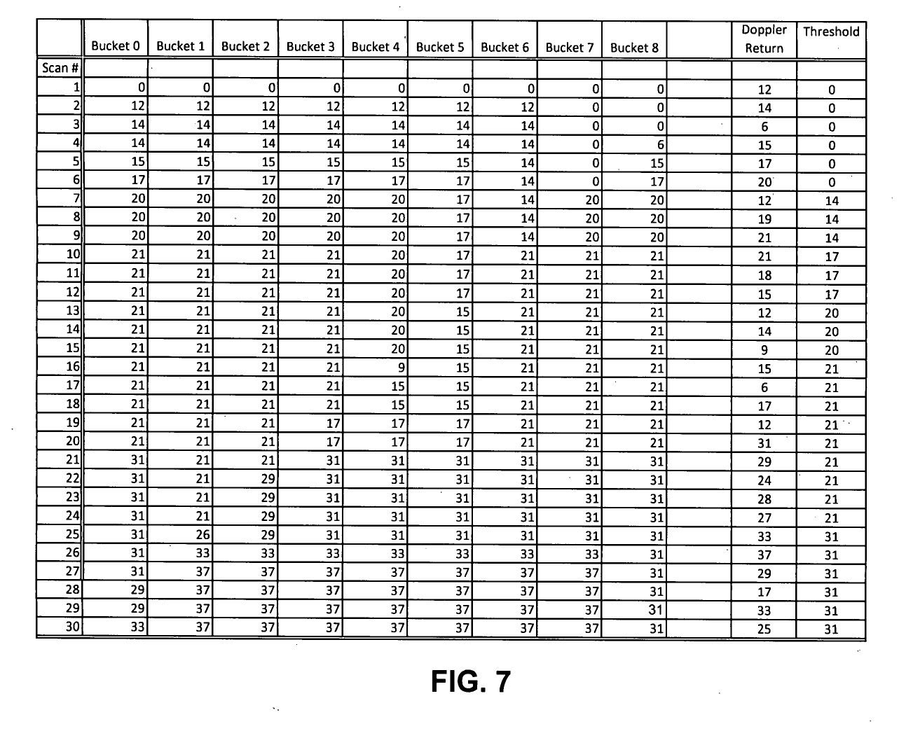

In this example, illustrated in FIGS. 6 and 7 there are 9 total buckets: 7 “write”, 1 “read”, and 1 “transition.” Here, the “write” buckets are updated every scan. The buckets “move forward” every three scans so with 7 “write” buckets, the threshold due to a blade flash will remain elevated for 21 scans. Further, since an active wind turbine cell generally produces a blade flash every six to ten scans, this 21 scan window ensures that its threshold remains elevated until it is no longer considered an active cell.

As in Example 3, the role of the writable buckets is to gather the maximum values of the Doppler returns received by the radar on each scan. Whenever a return is greater than that stored in the bucket, the new, larger maximum value is placed in the bucket. If the return is not greater than that already in the bucket, the content of the bucket remains the same. The “read” bucket also has the same role as before. The value in the “read” bucket is obtained from the “transition” bucket from the prior scan and read into the threshold which is effective for 3 scans in this example, and then the assigned roles of the buckets shift. After it is “read”, the “read” bucket again takes on the role of a “write” bucket, starting with a value of zero and comparing this value with the Doppler return for the previous scan, takes on the value of 6 dB for the present scan number 4. The next bucket in line to be read is bucket number 7, which had been the “transition” bucket. After it fulfills its role as a “read” bucket for three scans, it becomes a “write” bucket beginning at scan number 7, comparing its present reset content, zero, to the Doppler return value from scan number 6, choosing the greater value, 20 dB. In each case, the “transition” bucket has been frozen and contains the value that it had in the previous scan. In the case of scan number 7, it will hold the 17 dB value from scan number 6 for the three scans number 7, 8, and 9.

FIG. 6 shows the amplitude of the Doppler strength received by the radar system that is observing a wind generator having frequent blade flash activity. FIG. 7 shows the contents of buckets (rounded off for ease of comparison) and the accompanying thresholds. Initially all buckets are empty, set to zero as the radar system measures an initial Doppler return of 12 dB at scan number 1. This number is compared to the present contents of the 7 “write” buckets, namely zero, and the larger number displaces the lower value number in anticipation of scan number 2. Note then, that bucket zero through bucket 6 has written 12 dB as the maximum Doppler return, received thus far at the radar. The “transition” bucket, bucket 7 holds the value it held on the initial, that is, the scan that yielded zero. The “read” bucket, bucket 8, reads the value stored in the previous scan, scan number 1. This value is then used as the threshold for scan 2.

For each scan, the value of the threshold used for that scan is the value being read from the “read” bucket for that scan. For each scan, the value stored in the “transition” bucket is the same value stored in that bucket from the preceding scan. After each grouping of three scans has been completed, the role of the buckets changes continually. What had been the “transition” bucket for scans 1, 2, and 3 (bucket 7 of 9) now becomes the “write” bucket for scans 4, 5, and 6 (bucket 6 of 9). In a similar way, what had been the “read” bucket for scans 1, 2, and 3 (bucket 8 of 9), now becomes the “read” bucket for scans 4, 5, and 6 (bucket 7 of 9.) Likewise, the “write buckets assume different roles every three scans. Whereas, buckets zero, 1, 2, 3, 4, 5, and 6, and 7 (of 9) all compared their present contents with the value of the Doppler return from that scan to establish the content of the bucket for the subsequent scan. This comparison, you will recall, required the replacement of the present value stored in the bucket to be replaced by the value of the Doppler return if the power of the Doppler return from the present scan exceeded the value stored in the bucket. Otherwise, the value of the Doppler return remained the same. For scan number 4, the “write” buckets are now buckets zero, 1, 2, 3, 4, and 5 (of 9). Note that buckets zero through 6 have the same content, 14 dB, while bucket 8 has stored a value of 6 dB. This difference stems from the different history experienced by bucket 8 which is comparing the value it had from scan 3 (zero) to the power of the Doppler return for scan number 3 (6 dB.) Bucket 7, the new “transition” bucket has taken the 24 dB value from its previous value stored from scan number 3 and will keep that value over the all three scans, 4, 5, and 6

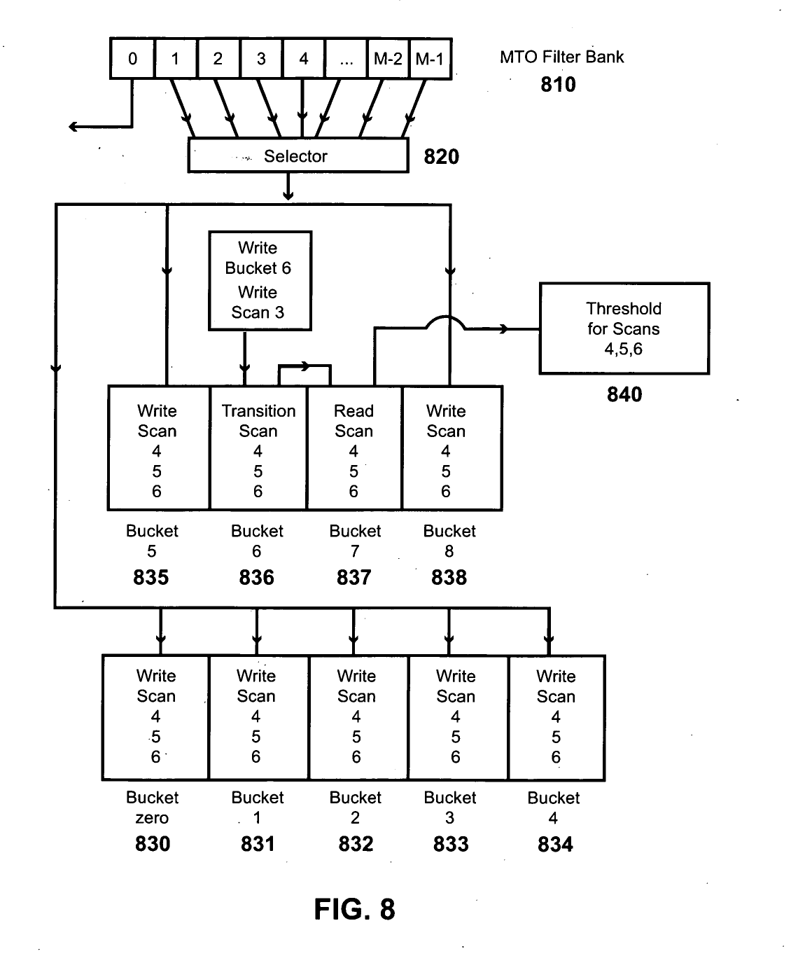

A radar device employing this embodiment of the invention is shown in FIG. 8 where the action of the device is captured during scans 4, 5, and 6. The whole Doppler return from scan 4 is fed into the MTD Filter Bank 810 which separates the signal according to the velocity of the sources with Filter Zero diverting its content away for analysis of static clutter in the Doppler signal. The remaining components of the Doppler return are arranged from the lower to the higher velocities by filters 1 to M-1. The contents of these non-zero contents of the MTD Filter Bank 810 for scan 4 is sent to the Selector 820 which identifies which of the non-zero contents is the largest and send that largest Doppler return component to the “Write” Buckets 830, 831, 832, 833, 834, 835, and 838. Bucket Number 6 836 for scans 4, 5, and 6, has the role of a “transition’ bucket and takes for its value the value it had when it was a “write” bucket in the previous scan 3. This value in “transition” bucket 836, is moved into the adjoining bucket 8, 838, the “read” bucket, and subsequently read as the threshold 840 for scan 4. Scans 5 and 6 are handled in the same manner. The contents of the “transition” bucket 836 have been frozen at the value it had at scan 4, so consequently the contents of the “read” bucket 837 and the threshold have remained the same for scans 5 and 6 as well. All the “write” buckets have continued as before so that by the end of scan 6, the contents of each of the write buckets are the greater of the maximum Doppler return for scan 6 and the previous content the “write” bucket had prior to scan 6.

To take a later example, examine the case presented for scan number 19. Scan 18 detected a Doppler return of 17 dB. For scan 19, buckets zero, 3, 4, 5, 6, 7 , and 8 (of 9) are in the role of “write” buckets, while bucket 1 is a “transition” bucket and bucket 2 is a “read” bucket. Prior history has left buckets 6, 7, and 8 with a higher value of 21 dB, while raising the prior historical values of buckets 4 and 5 to 17 dB. Since scan number 19 became the first scan setting the threshold for the next three scans, the “transition” bucket changed from bucket 2 to bucket 1 and the “read” bucket changed from bucket 3 to bucket 2. Bucket 1, the transition bucket, takes its value for scan 19 from its value from scan 18, namely 21 dB and Bucket 2, the “read” bucket whose contents for scan number 19 is taken from its content in scan number 18 and assigned the threshold for scans 19, 20 and 21. At scan 22, the process is repeated to yield a new three-scan threshold.

The Doppler return from scan 2 is 14 db. “Write” buckets zero through 6 still contain the 12 dB maximum derived from scan 1 analysis and, since they are still in “write” mode, their contents have not been read so they cannot have been analyzed to set a new threshold. For scan 3, however, buckets zero through 6 compare the Doppler return from scan 2, 14 dB, to the present value stored in the bucket, 12 dB, and since the newer measured return is greater than the value stored in buckets zero though 6, the previous maxima are raised to 14 dB.

Scan 3 shows a measured maximum Doppler return of 6 dB. The contents of buckets zero through 6 compare this maximum value, 6 dB to the present value contained in the bucket, 14 dB, and because the value of the Doppler return for scan 3 is less than the present value contained in buckets zero through 6, the existing value of 14 dB is retained for scan 4. The value stored in bucket 7 is frozen at the value from scan 2, the value of the “read” bucket, bucket 8, is also frozen at the value it had at scan 2 and the corresponding threshold remains at zero.

For Scan 4, the pattern changes and continues this pattern every 3 scans thereafter. Now that 3 scans have been completed, the role of some of the buckets changes. Buckets zero through 5 remain “write” buckets. Bucket 8 now becomes a “write” bucket but with a different history, than buckets zero through 5. Bucket 6 becomes a “transition” bucket and bucket 7 becomes a “read” bucket. As can be seen from FIG. 7, this shift of roles moves down the line of buckets. After each scan, the contents of the “read” bucket are used to set the threshold which will remain in effect for at least three scans.

Note that the “ramp up time” or the time that the threshold responds to a large Doppler return can be extended by the use of additional “transition” buckets Conversely, decay times can be extended by the addition of more “write” buckets.

Note also that the buckets are for analysis from lowest to highest number bucket; that for analysis, the starting point is the highest number bucket. The “transition” bucket is placed in the position just to the left of the “read” bucket, and the analysis proceed from the highest number bucket down to the lowest number and continually repeats this Process. Note again, that the radar technology employed may determine the practical number of buckets that may yield the best results.

While this specification has concentrated on the effect of a single wind turbine on a scanning radar, the invention may be beneficially embodied in other types of radars, such as phased array radars. Also, while the embodiment of the invention has been employed in the case of a single wind turbine, the embodiment may be extended to a multitude of wind turbines constituting a “wind farm.” In such a case, a map of the region occupied by the farm may be isolated from the entire area viewed by the radar and divided into cells each containing a wind turbine. Each cell is then subject to the analysis presented here and assigned dynamic thresholds for each scan. The entire map would then be reconstituted with the wind farm map, consisting of these cells with changing thresholds determined by at least one embodiment of the invention and the remaining portion of the map that is scanned as usual.

There are other variations that may be conceived within the spirit of this invention. For instance, the number of buckets can vary, adding “write” buckets when the goal is to extend the decay time of the threshold and adding “transition” buckets when the goal is to delay the onset of a threshold in the radar's performance. Also, while in the example above the threshold was updated after each set of three scans was analyzed, the number of accumulated scans can be any number before the threshold is updated.

1. (canceled)

2. In a Doppler radar system, a method for setting the threshold for the suppression of clutter generated by the rotating blades of a wind turbine, said method comprising the steps of:
1. Separating the total Doppler return from a radar scan of a region containing a wind turbine by means of a Doppler filter configured to spread the strength of said Doppler return across the n bins of said Doppler filter according to the velocity of the rotating blades causing the Doppler return;
2. Assembling 9 storage buckets, designated bucket zero through bucket 8, wherein each of said 9 storage buckets is capable of receiving and comparing two numerical values and storing the greater of the two numerical values, and wherein the said numerical values are proportional to the strength of the radar return from any one of the n bins of the said Doppler filter,
3. Selecting the single maximum numerical value from among said n bins of said Doppler filter for each scan of said region containing a wind turbine;
4. For scan number 1, designating buckets zero through 6 as WRITE buckets, each containing an initial value of zero, comparing the initial value stored in each of said buckets zero through 6 to the maximum Doppler return from scan number 1, and, storing the greater value in each of said buckets zero through 6 for scan number 2;
5. For scan number 2, comparing the present value stored in each of said buckets zero through 6, to the maximum Doppler return from scan number 2, and, storing the greater value in each of said buckets zero through 6 in scan number 3;
6. For scan number 3, comparing the present value stored in each of said buckets zero through 6, to the maximum Doppler return from scan number 3, and, storing the greater value in each of said buckets zero through 6 in scan number 4;
7. For scans 1, 2, and 3, designating storage bucket 7 as a TRANSITION bucket whose contents are set at zero for each of scans 1, 2, and 3;
8. For scan 1, 2, and 3, designating storage bucket 8 as a READ bucket whose contents are set at zero for each of scans 1, 2, and 3;
9. Setting the threshold for scan number 1 to be the contents of the READ bucket for scan number 3; setting the threshold for scan number 2 to be the contents of the READ bucket for scan number 3; and setting the threshold for scan number 3 to be the contents of the READ bucket for scan number 3, the contents of read buckets 1, 2, and 3 being equal,
10. For scans number 4 through 6, designating buckets zero through 5 and bucket 8 as WRITE buckets, comparing the present value stored in each of said buckets zero through 5 and bucket 8 to the maximum Doppler return from scan number 4, and storing the greater value in each of said buckets zero through 5 and bucket 8 in bucket 5;
11. For scan number 5, comparing the present value stored in each of said buckets zero through 5 and bucket 8, to the maximum Doppler return from scan number 5, and, storing the greater value in each of said buckets zero through 5 and bucket 8 in bucket 6;
12. For scan number 6, comparing the present value stored in each of said buckets zero through 5 and bucket 8, to the maximum Doppler return from scan number 6, and, storing the greater value in each of said buckets zero through 5 and bucket 8 in bucket 7;
13. For scans 4, 5, and 6, designating storage bucket 6 as a TRANSITION bucket whose contents remain the value stored in bucket 6 from the scan immediately prior to scan number 4;
14. For scans 4, 5, and 6, designating storage bucket 7 as a READ bucket whose contents remain the value read from the TRANSITION bucket for the scan immediately prior to scan number 4;
15. Setting the threshold for scan number 4 to be the contents of the READ bucket for scan number 6; setting the threshold for scan number 5 to be the contents of the READ bucket for scan number 6; setting the threshold for scan number 6 to be the contents of the READ bucket for scan number 6; the contents of READ buckets 4, 5, and 6 being equal,
16. For scans number 7 through 9, designating buckets zero through 4 and buckets 7 and 8 as WRITE buckets, comparing the present value stored in each of said buckets zero through 4 and buckets 7 and 8 to the maximum Doppler return from scan number 7, and storing the greater value in each of said buckets zero through 4 and buckets 7 and 8 in scan number 8;
17. For scan number 8, comparing the present value stored in each of said buckets zero through 4 and buckets 7 and 8, to the maximum Doppler return from scan number 8, and, storing the greater value in each of said buckets zero through 4 and buckets 7 and 8 in scan number 9;
18. For scan number 9, comparing the present value stored in each of said buckets zero through 4 and buckets 7 and 8, to the maximum Doppler return from scan number 9, and, storing the greater value in each of said buckets zero through 4 and buckets 7 and 8 in scan number 10;
19. For scans 7, 8, and 9, designating storage bucket 5 as a TRANSITION bucket whose contents remain the Value stored in bucket 5 from the scan immediately prior to scan number 7;
20. For scans 7, 8, and 9, designating storage bucket 6 as a READ bucket whose contents remain the value read from the transition bucket for the scan immediately prior to scan number 7;
21. Setting the threshold for scan number 7 to be the contents of the READ bucket for scan number 9; setting the threshold for scan number 8 to be the contents of the READ bucket for scan number 9; setting the threshold for scan number 9 to be the contents of the READ bucket for scan number 9, the contents of READ buckets 7, 8, and 9 being equal,
22. For scans number 10 through 12, designating buckets zero through 3 and buckets 6 through 8 WRITE buckets, comparing the present value stored in each of said buckets zero through 3 and buckets 6 through 8 to the maximum Doppler return from scan number 10, and storing the greater value in each of said buckets zero through 3 and buckets 6 through 8 in scan number 11;
23. For scan number 11, comparing the present value stored in each of said buckets zero through 3 and buckets 6 through 8, to the maximum Doppler return from scan number 11, and, storing the greater value in each of said buckets zero through 3 and buckets 6 through 8 in scan number 12;
24. For scan number 12, comparing the present value stored in each of said buckets zero through 3 and buckets 6 through 8, to the maximum Doppler return from scan number 12, and, storing the greater value in each of said buckets zero through 3 and buckets 6 through 8 in scan number 13;
25. For scans 10, 11, and 12, designating storage bucket 4 as a TRANSITION bucket whose contents remain the value stored in bucket 4 from the scan immediately prior to scan number 10;
26. For scans 10, 11, and 12, designating storage bucket 5 as a READ bucket whose contents remain the value read from the TRANSITION bucket for the scan immediately prior to scan number 10;
27. Setting the threshold for scan number 10 to be the contents of the READ bucket for scan number 12; setting the threshold for scan number 11 to be the contents of the READ bucket for scan number 12; setting the threshold for scan number 12 to be the contents of the READ bucket for scan number 12, the contents of read buckets 10, 11, and 12 being equal,
28. For scans number 13 through 15, designating buckets zero, 1, and 2 and buckets 5 through 8 WRITE buckets, comparing the present value stored in each of said buckets zero, 1, and 2 and buckets 5 through 8 to the maximum Doppler return from scan number 13, and storing the greater value in each of said buckets zero, 1, and 2 and buckets 5 through 8 for scan number 14;
29. For scan number 14, comparing the present value stored in each of said buckets zero, 1, and 2 and buckets 5 through 8, to the maximum Doppler return from scan number 14, and, storing the greater value in each of said buckets zero, 1, and 2 and buckets 5 through 8 in scan number 15;
30. For scan number 15, comparing the present value stored in each of said buckets zero, 1, and 2 and buckets 5 through 8, to the maximum Doppler return from scan number 15, and, storing the greater value in each of said buckets zero, 1, and 2, and buckets 5 through 8 in scan number 16;
31. For scans 13, 14, and 15, designating storage bucket 3 as a TRANSITION bucket whose contents remain the value stored in bucket 3 from the scan immediately prior to scan number 13;
32. For scans 13, 14, and 15, designating storage bucket 4 as a READ bucket whose contents remain the value read from the transition bucket for the scan immediately prior to scan number 13;
33. Setting the threshold for scan number 13 to be the contents of the READ bucket for scan number 15; setting the threshold for scan number 14 to be the contents of the READ bucket for scan number 15; setting the threshold for scan number 15 to be the contents of the READ bucket for scan number 15, the contents of READ buckets 13, 14, and 15 being equal,
34. For scans number 16 through 18, designating buckets zero, and 1, and buckets 4 through 8 WRITE buckets, comparing the present value stored in each of said buckets zero, and 1 and buckets 4 through 8 to the maximum Doppler return from scan number 16, and storing the greater value in each of said buckets zero, and 1 and buckets 4 through 8 in scan number 17;
35. For scan number 17, comparing the present value stored in each of said buckets zero and 1 and buckets 4 through 8, to the maximum Doppler return from scan number 17, and, storing the greater value in each of said buckets zero, and 1 and buckets 4 through 8 in scan number 18;
36. For scan number 18, comparing the present value stored in each of said buckets zero, and 1 and buckets 4 through 8, to the maximum Doppler return from scan number 18, and, storing the greater value in each of said buckets zero, and 1 and buckets 4, through 8 in scan number 19;
37. For scans 16, 17, and 18, designating storage bucket 2 as a TRANSITION bucket whose contents remain the value stored in bucket 2 from the scan immediately prior to scan number 16;
38. For scans 16, 17, and 18, designating storage bucket 3 as a READ bucket whose contents remain the value READ from the transition bucket for the scan immediately prior to scan number 16;
39. Setting the threshold for scan number 16 to be the contents of the READ bucket for scan number 18; setting the threshold for scan number 17 to be the contents of the READ bucket for scan number 18; setting the threshold for scan number 18 to be the contents of the READ bucket for scan number 18, the contents of READ buckets 16, 17, and 18 being equal,
40. For scans number 19 through 21, designating buckets zero and buckets 3 through 8 WRITE buckets, comparing the present value stored in each of said buckets zero buckets 3 through 8 to the maximum Doppler return from scan number 19, and storing the greater value in each of said buckets zero and buckets 3 through 8 in scan number 20;
41. For scan number 20, comparing the present value stored in each of said bucket zero and buckets 3 through 8, to the maximum Doppler return from scan number 20, and, storing the greater value in each of said bucket zero and buckets 3 through 8 in scan number 21;
42. For scan number 21, comparing the present value stored in each of said bucket zero and buckets 3 through 8, to the maximum Doppler return from scan number 21, and, storing the greater value in each of said bucket zero and buckets 3 through 8 in scan number 22;
43. For scans 19, 20, and 21, designating storage bucket 1 as a TRANSITION bucket whose contents remain the value stored in bucket 1 from the scan immediately prior to scan number 19;
44. For scans 19, 20, and 21, designating storage bucket 2 as a READ bucket whose contents remain the value read from the transition bucket for the scan immediately prior to scan number 19;
45. Setting the threshold for scan number 19 to be the contents of the READ bucket for scan number 21; setting the threshold for scan number 20 to be the contents of the READ bucket for scan number 21; setting the threshold for scan number 20 to be the contents of the READ bucket for scan number 21, the contents of READ buckets 19, 20, and 21 being equal,
46. For scans number 22 through 24, designating buckets 2 through 8 WRITE buckets, comparing the present value stored in each of said buckets 2 through 8 to the maximum Doppler return from scan number 22, and storing the greater value in each of said buckets 2 through 8 in scan number 23;
47. For scan number 23, comparing the present value stored in each of said buckets 2 through 8, to the maximum Doppler return from scan number 23, and, storing the greater value in each of said buckets 2 through 8 in scan number 24;
48. For scan number 24, comparing the present value stored in each of said buckets 2 through 8, to the maximum Doppler return from scan number 24, and, storing the greater value in each of said buckets 2 through 8 in scan number 25;
49. For scans 22, 23, and 24, designating storage bucket zero as a TRANSITION bucket whose contents remain the value stored in bucket zero from the scan immediately prior to scan number 22;
50. For scans 22, 23, and 24, designating storage bucket 1 as a READ bucket whose contents remain the value read from the transition bucket for the scan immediately prior to scan number 22;
51. Setting the threshold for scan number 22 to be the contents of the READ bucket for scan number 24; setting the threshold for scan number 23 to be the contents of the READ bucket for scan number 24; setting the threshold for scan number 24 to be the contents of the READ bucket for scan number 24, the contents of READ buckets 22, 23, and 24 being equal,
52. For scans number 25 through 27 designating buckets 1 through 7 WRITE buckets, comparing the present value stored in each of said buckets 1 through 7 to the maximum Doppler return from scan number 25, and storing the greater value in each of said buckets 1 through 7 in scan number 26;
53. For scan number 26, comparing the present value stored in each of said buckets 1 through 7, to the maximum Doppler return from scan number 26, and, storing the greater value in each of said buckets 1 through 7 in scan 27;
54. For scan number 27, comparing the present value stored in each of said buckets 1 through 7, to the maximum Doppler return from scan number 27, and, storing the greater value in each of said buckets 1 through 7 in scan number 28;
55. For scans 25, 26, and 27, designating storage bucket 8 as a TRANSITION bucket whose contents remain the value stored in bucket 8 from the scan immediately prior to scan number 25;
56. For scans 25, 26, and 27, designating storage bucket zero as a READ bucket whose contents remain the value read from the transition bucket for the scan immediately prior to scan number 25;
57. Setting the threshold for scan number 25 to be the contents of the READ bucket for scan number 27; setting the threshold for scan number 26 to be the contents of the READ bucket for scan number 27; setting the threshold for scan number 27 to be the contents of the READ bucket for scan number 27, the contents of READ buckets 25, 26, and 27 being equal,
58. For scans number 28 through 30 designating buckets zero through 6 WRITE buckets, comparing the present value stored in each of said buckets zero through 6 to the maximum Doppler return from scan number 28, and storing the greater value in each of said buckets zero through 6 in scan number 29;
59. For scan number 29, comparing the present value stored in each of said buckets zero through 6, to the maximum Doppler return from scan number 29, and, storing the greater value in each of said buckets zero through 6 in scan number 30;
60. For scan number 30, comparing the present value stored in each of said buckets zero through 6 the maximum Doppler return from scan number 27, and, storing the greater value in each of said buckets zero through 6 in scan number 31;
61. For scans 28, 29, and 30, designating storage bucket 7 as a TRANSITION bucket whose contents remain the value stored in bucket 7 from the scan immediately prior to scan number 28;
62. For scans 28, 29, and 30, designating storage bucket 8 as a READ bucket whose contents remain the value read from the transition bucket for the scan immediately prior to scan number 28;
63. Setting the threshold for scan number 28 to be the contents of the READ bucket for scan number 30; setting the threshold for scan number 29 to be the contents of the READ bucket for scan number 30; setting the threshold for scan number 30 to be the contents of the READ bucket for scan number 30, the contents of read buckets 28, 29, and 30 being equal,
64. For scans number 31 through 33 designating bucket 8 and buckets zero through 5 “write” buckets, comparing the present value stored in each of said bucket 8 and buckets zero through 5 to the maximum Doppler return from scan number 31, and storing the greater value in each of said bucket 8 and buckets zero through 5 in scan number 34;
65. For scan number 32, comparing the present value stored in each of said bucket 8 and buckets zero through 5, to the maximum Doppler return from scan number 32, and, storing the greater value in each of said bucket 8 and buckets zero through 5 in scan number 34;
66. For scan number 33, comparing the present value stored in each of said bucket 8 and buckets zero through 5 the maximum Doppler return from scan number 33, and, storing the greater value in each of said bucket 8 and buckets zero through 5 in scan number 34;
67. For scans 31, 32 and 33, designating storage bucket 6 as a “transition” bucket whose contents remain the value stored in bucket 6 from the scan immediately prior to scan number 31;
68. For scans 31, 32, and 33, designating storage bucket 7 as a “read” bucket whose contents remain the value read from the transition bucket for the scan immediately prior to scan number 28;
69. Setting the threshold for scan number 31 to be the contents of the read bucket for scan number 33; setting the threshold for scan number 32 to be the contents of the read bucket for scan number 33; setting the threshold for scan number 33 stored to be the contents of the read bucket for scan number 33, the contents of read buckets 31, 32, and 33 being equal,
70. Repeat steps for scans 4 through 30 to generate said threshold for the next group of 27 scans and continue to repeat in groups of 27 scans for as long as desired.

3. A method to establish a threshold to suppress the false alarm rate produced by the periodic radar scan of a region occupied by a wind turbine having at least one rotating blade, said method comprising the steps of:
a. Detecting radar returns from said region over N number of scans;
b. Passing each said radar return from each said scan through a Doppler filter having n outputs, each of said outputs being a number proportional to the strength of said radar return produced by that said rotating blade producing said radar return and wherein each of said n outputs represent a velocity range for the velocity of said rotating blade parallel to the direction of the radar return and wherein the n outputs cover the range of interest of velocities of said rotating blade;
c. Selecting from the n outputs of said Doppler filter, the maximum value for each of said N scans and storing said maximum values in storage buckets 1 through N respectively;
d. Choosing the maximum value among said maximum values stored in storage buckets 1 through N;
e. Establish said maximum value determined in step d as the threshold for the next N scans of said region occupied by said wind turbine; and
f. Repeat steps a through e for the next N scans.

4. A method to establish a threshold to suppress the false alarm rate produced by the periodic radar scan of a region occupied by a wind turbine having rotating parts, said method comprising the steps of:
a. Detecting radar returns from said region over N number of scans;
b. Passing each said radar return from each said scan through a Doppler filter having n outputs, each of said outputs being a number proportional to the strength of said radar return produced by one of said rotating parts producing said radar return and wherein each of said n outputs represent a velocity range for the velocity of said one of said rotating parts parallel to the direction of the radar return and wherein the n outputs cover the range of velocities of said rotating parts of interest;
c. Selecting from the n outputs of said Doppler filter, the maximum value for each of said N scans and storing said maximum values in storage buckets 1 through N respectively;
d. Choosing the maximum value among said maximum values stored in storage buckets 1 through N, said maximum value being closest in time to storage bucket N;
e. Establish said maximum value determined in step d as the threshold for the next N scans of said region occupied by said wind turbine; and
f. Repeat steps a through e for the next N scans.
